(19) United States
(12) Patent Application Publication
(10) Pub. No.: US 2026/0109600 A1
(43) Pub. Date: Apr. 23, 2026

(54) EQUIPMENT FOR PREPARING HYDROGEN AND METHOD FOR PREPARING HYDROGEN

(71) Applicants: HYUNDAI MOTOR COMPANY, Seoul (KR); Kia Corporation, Seoul (KR)

(72) Inventors: Jung Joo PARK, Hwaseong-si (KR); Jun Ho JANG, Hwaseong-si (KR); Jae Myung LEE, Hwaseong-si (KR)

(73) Assignees: HYUNDAI MOTOR COMPANY, Seoul (KR); Kia Corporation, Seoul (KR)

(21) Appl. No.: 19/064,483

(22) Filed: Feb. 26, 2025

(30) Foreign Application Priority Data
Oct. 17, 2024 (KR) 10-2024-0142402

(51) Int. Cl. C01B 3/48

(52) U.S. Cl. CPC C01B 3/48; C01B 2203/0211; C01B 2203/0811; C01B 2203/0883

(57) ABSTRACT

In an apparatus and a method for preparing hydrogen, the apparatus includes a reformer that induces a first reaction of methane contained in biogas and carbon dioxide and a second reaction of the methane contained in the biogas and separately supplied water to produce first gas containing hydrogen and carbon monoxide, and water gas shift reactor that induces a third reaction of the carbon monoxide contained in the first gas and water to produce second gas containing hydrogen and carbon dioxide, and the separately supplied water is water contained in the second gas discharged from the water gas shift reactor or water obtained by combusting methane contained in the biogas.

### CROSS-REFERENCE TO RELATED APPLICATION

The present application claims priority to Korean Patent Application No. 10-2024-0142402, filed on Oct. 17, 2024, the entire contents of which is incorporated herein for all purposes by this reference.

### BACKGROUND OF THE PRESENT DISCLOSURE

### Field of the Present Disclosure

The present disclosure relates to an equipment and a method for preparing hydrogen in which water is separately supplied during a reforming reaction of biogas including methane and carbon dioxide so that dry reforming and steam reforming are simultaneously performed, achieving an excellent hydrogen production yield and reducing coking caused by thermal decomposition of methane.

### Description of Related Art

Hydrogen gas is attracting attention as an eco-friendly energy source, and thus, various methods for producing hydrogen gas are being provided. Among the methods for preparing hydrogen gas, a method for preparing hydrogen from biogas is eco-friendly in that it utilizes the biogas as a waste product. Furthermore, the method for preparing hydrogen from the biogas typically includes a process of concentrating methane in the biogas, purifying and removing impurities such as moisture and sulfur compounds therefrom, and then reforming the purified methane.

Recently, a dry methane reforming method (CH₄+CO₂→2H₂+2CO) in which methane in biogas reacts with carbon dioxide known as the greenhouse gas to produce hydrogen while simultaneously reducing the carbon dioxide has been attracting attention. For example, Korean Patent Application Publication No. 2023-0106305 (Patent Document 1) discloses a hybrid system including a carbon dioxide separation membrane that separates biogas into methane and carbon dioxide; a reforming reactor that receives methane and carbon dioxide to produce synthesized gas; a hydrogen separation membrane that receives the synthesized gas to separate hydrogen therefrom; and a water gas generator that receives carbon monoxide separated from the hydrogen separation membrane and receives water at one side thereof to shift the carbon monoxide into water gas. However, the dry methane reforming method of the patent document 1 has a problem that coke is formed on the catalyst, reducing the catalytic activity or reactivity so that the hydrogen production yield is lowered, compared to a widely used steam methane reforming method.

Therefore, research and development are necessary for a method and equipment of preparing hydrogen from biogas in which the coking occurrence is reduced, preventing decrease in reactivity, and achieving an excellent hydrogen production yield.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing equipment and a method for preparing hydrogen which may reduce coking occurrence due to thermal decomposition of methane in biogas containing methane and carbon dioxide, preventing decrease in activity of a reforming catalyst, and allowing the methane reforming reaction to proceed more actively, achieving an excellent hydrogen production yield.

The technical problems to be solved by the present disclosure are not limited to the aforementioned problems, and any other technical problems not mentioned herein will be clearly understood from the following description by those skilled in the art to which the present disclosure pertains.

According to an aspect of the present disclosure, equipment for preparing hydrogen includes a reformer that induces a first reaction of methane contained in biogas and carbon dioxide and a second reaction of the methane contained in the biogas and separately supplied water to produce first gas containing hydrogen and carbon monoxide; and a water gas shift reactor that induces a third reaction of the carbon monoxide contained in the first gas and water to produce second gas containing hydrogen and carbon dioxide, wherein the separately supplied water is water contained in the second gas discharged from the water gas shift reactor or water obtained by combusting methane contained in the biogas.

According to an aspect of the present disclosure, the method for preparing hydrogen includes a reforming step of inducing a first reaction of methane contained in biogas and carbon dioxide and a second reaction of the methane contained in the biogas and separately supplied water to produce first gas containing hydrogen and carbon monoxide; and a water gas shift step of inducing a third reaction of the carbon monoxide contained in the first gas and water to produce second gas containing hydrogen and carbon dioxide, wherein the separately supplied water is water contained in the second gas discharged from the water gas shift step or water obtained by combusting methane contained in the biogas.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1, FIG. 2, FIG. 3, FIG. 4, FIG. 5 and FIG. 6 are flow charts of equipment for preparing hydrogen according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

The present disclosure is described in detail below.

### Equipment for Preparing Hydrogen

The equipment for preparing hydrogen according to an exemplary embodiment of the present disclosure includes a reformer and a water gas shift reactor, wherein water is separately supplied to the reformer.

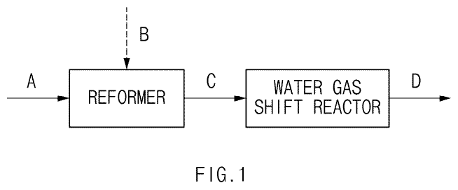

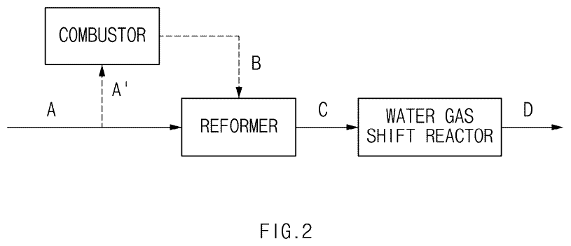

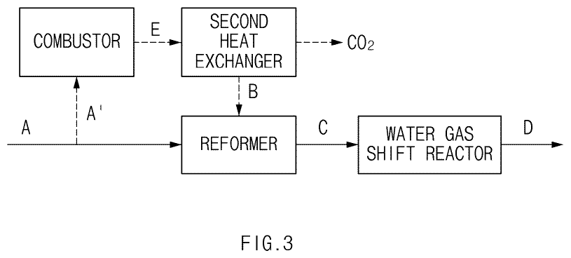

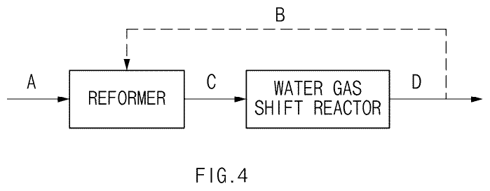

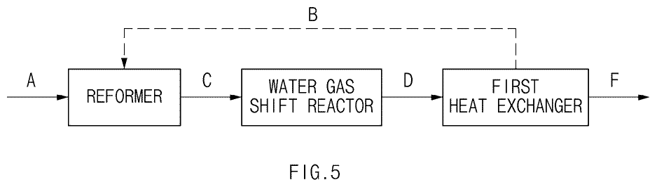

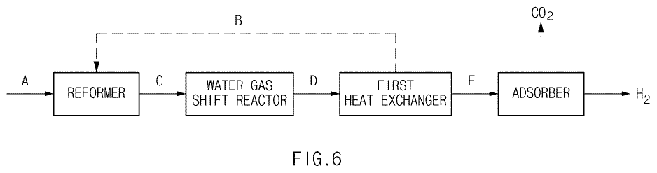

Referring to FIG. 1, the equipment for preparing hydrogen according to an exemplary embodiment of the present disclosure is supplied with biogas A and water B, and includes the reformer and the water gas shift reactor.

The equipment for preparing hydrogen includes the reformer and the water gas shift reactor sequentially, so that after a reforming reaction of methane, a water gas shift reaction proceeds, resulting in an excellent hydrogen production yield. Furthermore, the equipment for preparing hydrogen separately supplies water during the reforming of methane contained in the biogas so that a methane shift percentage is increased while coking is suppressed.

### Reformer

In the reformer, a first reaction of methane contained in biogas and carbon dioxide, and a second reaction of methane contained in the biogas and separately supplied water are induced to produce first gas containing hydrogen and carbon monoxide. Referring to FIG. 1, biogas A and water B are supplied to the reformer in which the first reaction and the second reaction are induced to produce first gas C containing hydrogen and carbon monoxide.

In the reformer, the first reaction (CH₄+CO₂→2H₂+2CO) as a dry reforming reaction (DR) in which methane and carbon dioxide react with each other, and the second reaction (CH₄+H₂O→3H₂+CO) as a steam reforming reaction (steam methane reforming reaction: SMR) in which methane and water react with each other are performed simultaneously. That is, in the reformer, a dry-steam combined reforming reaction (stream CO₂ reforming reaction) of 3CH₄+CO₂+2H₂O→8H₂+4CO reaction is performed. Thus, the equipment for preparing hydrogen according to an exemplary embodiment of the present disclosure has a significantly excellent hydrogen production efficiency due to steam and dry reforming decomposition of methane.

On the other hand, when hydrogen is produced only under the first reaction as the dry reforming reaction in which methane and carbon dioxide react each other, coke may be formed on catalyst due to thermal decomposition of methane (CH₄→C+2H₂), lowering catalytic activity or reactivity, resulting in a lower hydrogen production yield.

In the reformer, the first reaction may proceed as the main reaction, and the second reaction may proceed as a side reaction. As a result, the equipment according to an exemplary embodiment of the present disclosure consumes a larger amount of carbon dioxide known as the greenhouse gas, and thus is excellent in terms of environmental friendliness, compared to the case where hydrogen is produced only under the second reaction.

Furthermore, in the reformer, the first reaction and the second reaction are performed simultaneously, so that a significant portion of the methane in the biogas is decomposed by carbon dioxide and water, compared to the case where the first reaction and the second reaction are performed sequentially, reducing the occurrence of the coking due to thermal decomposition of methane, and improving the efficiency of the first reaction (dry reforming reaction) and the second reaction (steam reforming reaction), maximizing the hydrogen production yield.

Each of the first reaction and the second reaction as described above is an endothermic reaction, and thus, a heat source that supplies heat required for the reaction in the reformer may be additionally included in the equipment. The heat source may be used without particular limitations thereto as long as the heat source is generally available as a heat source in the endothermic reaction. For example, the heat source may include a burner, a heat-exchanger, etc.

Furthermore, the reformer may include at least one catalyst selected from the group consisting of a catalyst for performing the first reaction as the dry reforming reaction, and a catalyst for performing the second reaction as the steam reforming reaction. Each of the catalyst for the first reaction and the catalyst for the second reaction may be used without particular limitations thereto as long as each of the catalysts is typically used in the reforming reaction, and is able to be prepared and/or available for purchase.

The water separately supplied to the reformer is water contained in the second gas discharged from the water gas shift reactor, or water obtained by combusting methane contained in the biogas.

For example, the water separately supplied to the reformer may be water obtained by combusting methane contained in the biogas. Referring to FIG. 2, the equipment for preparing hydrogen according to an exemplary embodiment of the present disclosure may supply, to the reformer, a portion of third gas containing the water B and the carbon dioxide, as obtained by combusting methane contained in the biogas A.

### Combustor

The combustor is configured to combust methane contained in biogas to produce water.

Furthermore, the heat generated in the combustor may be supplied to the reformer. That is, the heat generated in the combustor is supplied to the reformer as an endothermic reactor, and the portion of the third gas containing water and carbon dioxide as produced from the combustor may also be supplied to the reformer.

In this regard, the third gas discharged from the combustor may have a temperature of 350° C. or higher than 350° C., 380° C. or higher than 380° C., 400° C. or higher than 400° C., 550° C. or lower than 550° C., 530° C. or lower than 530° C., or 500° C. or lower than 500° C. As a result, the third gas may include water in a form of water vapor and carbon dioxide in a gas phase.

The equipment for preparing hydrogen may include a second heat-exchanger to cool the third gas to separate the third gas into gas and liquid.

### Second Heat-Exchanger

The second heat-exchanger is configured to cool the third gas discharged from the combustor to separate the third gas into gas and liquid.

In this regard, the gas-liquid separation may be to separate the third gas into water and carbon dioxide, or to separate the third gas into water, nitrogen, and carbon dioxide.

The cooling may be to bring the temperature of the third gas to room temperature, for example, 15° C. or higher than 15° C., 18° C. or higher than 18° C., 20° C. or higher than 20° C., 30° C. or lower than 30° C., 28° C. or lower than 28° C., or 25° C. or lower than 25° C. However, a target temperature is not limited thereto. The third gas may be cooled in the second heat-exchanger and thus be subjected to gas-liquid separation into water in a form of a liquid phase and carbon dioxide and/or nitrogen in a form of a gas phase. In this regard, the water in a form of the liquid phase in the third gas may be supplied to the reformer, and the carbon dioxide and/or the nitrogen in a form of the gas phase in the third gas may be discharged to an outside thereof.

The water discharged from the second heat-exchanger may be supplied to the reformer.

For example, the water discharged from the second heat-exchanger may be liquid, and a temperature thereof may be room temperature, for example, 15° C. or higher than 15° C., 18° C. or higher than 18° C., 20° C. or higher than 20° C., 30° C. or lower than 30° C., 28° C. or lower than 28° C., or 25° C. or lower than 25° C. When the water discharged from the second heat-exchanger is liquid, the temperature thereof is room temperature, the separation performance thereof from carbon dioxide may be improved, and only the water may be supplied to the reformer, improving the shift percentage of methane.

Referring to FIG. 3, the equipment for preparing hydrogen according to an exemplary embodiment of the present disclosure may include the second heat-exchanger that cools the third gas E discharged from the combustor to separate the third gas E into gas and liquid. The water B produced during the present process may then be supplied to the reformer.

### Water Gas Shift Reactor

In the water gas shift reactor, a third reaction between carbon monoxide contained in the first gas and water is induced, producing the second gas containing hydrogen and carbon dioxide.

The third reaction may be a water-gas shift reaction (WGS) (CO+H₂O→CO₂+H₂).

Furthermore, the water gas shift reactor may include a WGS catalyst that promotes the third reaction, that is, the water gas shift reaction (WGS). The WGS catalyst may be used without particular limitations thereto as long as the WGS catalyst is typically used in WGS, and is able to be prepared and/or available for purchase.

A content of water supplied to the water gas shift reactor may be 1.2 mol or larger than 1.2 mol, 1.3 mol or larger than 1.3 mol, 1.5 mol or larger than 1.5 mol, 1.8 mol or larger than 1.8 mol, 2.5 mol or smaller than 2.5 mol, 2.3 mol or smaller than 2.3 mol, 2.2 mol or smaller than 2.2 mol, or 2.1 mol or smaller than 2.1 mol, relative to the number of moles of carbon monoxide. That is, the water gas shift reaction involves a reaction at a 1:1 molar ratio of carbon monoxide and water. However, carbon monoxide and water may be supplied to the water gas shift reactor so that the molar ratio of water and carbon monoxide is in a range as described above. When the molar ratio of water and carbon monoxide supplied to the water gas shift reactor is within the above range, the shift percentage of carbon monoxide may be improved, improving the hydrogen production rate.

As described above, an amount of the water supplied to the water gas shift reactor may exceed an amount thereof required for the third reaction. As a result, the second gas discharged from the water gas shift reactor may contain water.

For example, the water separately supplied to the reformer may be water contained in the second gas discharged from the water gas shift reactor. Referring to FIG. 4, the equipment for preparing hydrogen according to an exemplary embodiment of the present disclosure may supply, to the reformer, the water B contained in the second gas D as discharged from the water gas shift reactor.

The third reaction may have a reaction temperature of 150° C. or higher than 150° C., 180° C. or higher than 180° C., 200° C. or higher than 200° C., 350° C. or lower than 350° C., 320° C. or lower than 320° C., or 300° C. or lower than 300° C. That is, the prepared second gas may have a temperature of 150° C. or higher than 150° C., 180° C. or higher than 180° C., 200° C. or higher than 200° C., 350° C. or lower than 350° C., 320° C. or lower than 320° C., or 300° C. or lower than 300° C. When the temperature of the second gas is within the above range, the WGS reaction may proceed smoothly, improving the shift performance of carbon monoxide (CO).

For example, the second gas may contain water in a form of water vapor and carbon dioxide in the gas phase.

The equipment for preparing hydrogen may supply, to the reformer, a portion of the second gas containing water in the gas phase and carbon dioxide in the gas phase as discharged from the water gas shift reactor.

The equipment for preparing hydrogen may include a first heat-exchanger for cooling the second gas to separate the second gas into the gas and liquid.

### First Heat-Exchanger

The first heat-exchanger is configured to cool the second gas discharged from the water gas shift reactor to separate the second gas into gas and liquid. In this regard, the gas-liquid separation may be to separate the second gas into water and carbon dioxide.

The cooling may be to bring the temperature of the second gas to room temperature, for example, 15° C. or higher than 15° C., 18° C. or higher than 18° C., 20° C. or higher than 20° C., 30° C. or lower than 30° C., 28° C. or lower than 28° C., or 25° C. or lower than 25° C. However, a target temperature is not limited thereto.

The second gas may be cooled in the first heat-exchanger and may be subjected to gas-liquid separation into water in a form of a liquid phase and hydrogen and/or carbon dioxide in a form of a gas phase. In this regard, the water in a form of the liquid phase in the second gas may be supplied to the reformer, and the hydrogen and/or the carbon dioxide in a form of the gas phase in the second gas may be discharged to the outside thereof.

The water discharged from the first heat-exchanger may be supplied to the reformer.

For example, the water discharged from the first heat-exchanger may be liquid, and a temperature thereof may be room temperature, for example, 15° C. or higher than 15° C., 18° C. or higher than 18° C., 20° C. or higher than 20° C., 30° C. or lower than 30° C., 28° C. or lower than 28° C., or 25° C. or lower than 25° C.

Referring to FIG. 5, the equipment for preparing hydrogen according to an exemplary embodiment of the present disclosure may include the first heat-exchanger that cools the second gas D discharged from the water gas shift reactor to separate the second gas D into gas and liquid. The water B produced during the present process may then be supplied to the reformer.

Fourth gas F discharged from the first heat-exchanger may contain hydrogen and carbon dioxide, and may not contain water (see FIG. 5).

The equipment for preparing hydrogen according to an exemplary embodiment of the present disclosure may include an adsorber that separates and purifies the second gas discharged from the water gas shift reactor.

Referring to FIG. 6, the equipment for preparing hydrogen according to an exemplary embodiment of the present disclosure may include the adsorber that separates and purifies the second gas D discharged from the water gas shift reactor.

### Adsorber

The adsorber is configured to separate, adsorb, and purify hydrogen gas from the second gas and then discharge the purified gas. In this regard, the adsorber may separate the second gas discharged from the water gas shift reactor into hydrogen gas and carbon dioxide via adsorption.

Furthermore, the adsorber may be used without particular limitations thereto as long as the adsorber is generally usable in separating and purifying hydrogen gas from mixed gas. For example, the adsorber may perform pressure swing adsorption (PSA).

The adsorber may include a plurality of adsorbing towers. For example, the number of adsorbing towers may be in a range of 3 to 12. The adsorbing tower may be filled with an adsorbing agent. In this regard, the adsorbing agent may be used without particular limitations thereto as long as the adsorbing agent is generally usable in purifying hydrogen gas. For example, the adsorbing agent may be a carbon-based material, a zeolite-based material, etc. The adsorbing agent may include activated carbon, aluminosilicate, pure silicate, titanosilicate, aluminophosphate, etc.

Furthermore, the hydrogen gas discharged from the adsorber has a purity of 99% or higher than 99%, 99.9% or higher than 99.9%, or 99.97% or higher than 99.97%, so that the hydrogen gas may be used as a raw material for a fuel cell, etc. without additional purification.

For example, the equipment for preparing hydrogen may include the first heat-exchanger that cools the second gas to separate the second gas into the gas and liquid, producing water and the fourth gas; and the adsorber that separates and purifies the fourth gas discharged from the first heat-exchanger.

Referring to FIG. 6, the equipment for preparing hydrogen according to an exemplary embodiment of the present disclosure may include the reformer that receives biogas A and water B and induces the first reaction and the second reaction, producing first gas C containing hydrogen and carbon monoxide; the water gas shift reactor that produces the second gas D; the first heat-exchanger that cools the second gas D to separate the second gas D into gas and liquid; and the adsorber that separates and purifies the fourth gas F discharged from the first heat-exchanger to produce hydrogen (H₂). In this regard, the water B separately supplied to the reformer may be water discharged from the first heat-exchanger.

Furthermore, the equipment for preparing hydrogen may include a control valve that adjusts a flow rate of water to be separately supplied to the reformer. Controlling the flow rate of water to be supplied separately to the reformer via the control valve may allow a reaction rate of each of the first reaction and the second reaction in the reformer to be controlled. As a result, the equipment for preparing hydrogen may have a more excellent hydrogen production yield.

The equipment for preparing hydrogen according to an exemplary embodiment of the present disclosure as described above separately supplies water during the reforming reaction so that the dry reforming and the steam reforming are performed simultaneously, achieving the excellent hydrogen production yield. Furthermore, the equipment for preparing hydrogen may reduce the occurrence of the coking as caused by thermal decomposition of methane, preventing decrease in the activity of the reforming catalyst.

### Method for Preparing Hydrogen

The method for preparing hydrogen according to an exemplary embodiment of the present disclosure includes a reforming step; and a water gas shift step, wherein water is supplied separately in the reforming step.

In the method for preparing hydrogen, the reforming step and the water gas shift step are sequentially performed, so that after the reforming reaction of methane, the water gas shift reaction proceeds, improving the hydrogen production yield. Furthermore, in the method, separate water is supplied in the reforming step so that the shift percentage of methane is improved while suppressing the coking.

### Reforming Step

In the reforming step, a first reaction of methane and carbon dioxide contained in biogas, and a second reaction of separately supplied water contained in the biogas produce the first gas containing hydrogen and carbon monoxide.

In the reforming step, the first reaction (CH₄+CO₂→2H₂+2CO) as a dry reforming reaction (DR) in which methane and carbon dioxide react each other, and the second reaction (CH₄+H₂O→+3H₂+CO) as a steam reforming reaction (steam methane reforming: SMR) in which methane and water react each other are performed simultaneously. That is, in the reformer, a dry-steam combined reforming reaction (stream CO₂ reforming) of 3CH₄+CO₂+2H₂O→8H₂+4CO reaction is performed. Thus, the equipment for preparing hydrogen according to an exemplary embodiment of the present disclosure has a significantly excellent hydrogen production efficiency due to steam and dry reforming decomposition of methane.

On the other hand, when hydrogen is produced only under the first reaction as the dry reforming reaction in which methane and carbon dioxide react each other, coke may be formed on catalyst due to thermal decomposition of methane (CH₄→C+2H₂), lowering catalytic activity or reactivity, resulting in a lower hydrogen production yield.

Furthermore, when hydrogen is produced only under the second reaction as a steam reforming reaction in which methane and water react each other, a pretreatment process for separating the raw material biogas into methane and carbon dioxide is required, complicating the process.

In the reforming step, the first reaction may proceed as the main reaction, and the second reaction may proceed as a side reaction. As a result, the method for preparing hydrogen according to an exemplary embodiment of the present disclosure consumes a larger amount of carbon dioxide known as the greenhouse gas, and thus is excellent in terms of environmental friendliness, compared to the case where hydrogen is produced only under the second reaction.

Furthermore, in the reforming step, the first reaction and the second reaction are performed simultaneously, so that a significant portion of the methane in the biogas is decomposed by carbon dioxide and water, compared to the case where the first reaction and the second reaction are performed sequentially, reducing the occurrence of the coking due to thermal decomposition of methane, and improving the efficiency of the first reaction (dry reforming reaction) and the second reaction (steam reforming reaction), maximizing the hydrogen production yield.

Each of the first reaction and the second reaction as described above is an endothermic reaction, and thus, a heat source that supplies heat required for the reaction in the reformer may be additionally included in the equipment. The heat source may be used without particular limitations thereto as long as the heat source is generally available as a heat source in the endothermic reaction. For example, the heat source may include a burner, a heat-exchanger, etc.

The temperature in the reforming step may be 750° C. or higher than 750° C., 760° C. or higher than 760° C., 780° C. or higher than 780° C., 800° C. or higher than 800° C., 950° C. or lower than 950° C., 940° C. or lower than 940° C., 930° C. or lower than 930° C., 910° C. or lower than 910° C., or 900° C. or lower than 900° C. When the temperature in the reforming step is within the above range, the side reaction causing cocking is suppressed, preventing the decrease in the activity of the catalyst, and improving the efficiency of the methane reforming reaction, improving the hydrogen production yield.

Furthermore, the reforming step may be performed under presence of at least one catalyst selected from the group consisting of a catalyst for performing the first reaction as the dry reforming reaction, and a catalyst for performing the second reaction as the steam reforming reaction. Each of the catalyst for the first reaction and the catalyst for the second reaction may be used without particular limitations thereto as long as each of the catalysts is typically used in the reforming reaction, and is able to be prepared and/or available for purchase.

The molar ratio of methane in the biogas supplied in the reforming step and the water supplied separately in the reforming step may be in a range of 1:0.3 inclusive to 0.7 inclusive. When the content of water supplied in the reforming step is within the above range, the yield of the methane reforming reaction is improved, improving the yield of hydrogen production, and the thermal decomposition reaction of methane is reduced so that the side reaction that causes cocking may be suppressed, preventing the decrease in the activity of the catalyst.

When the water supplied separately in the reforming step is obtained by combusting methane contained in the biogas, a combustion step to combust methane contained in the biogas to produce the third gas containing water and carbon dioxide may be included in the method.

### Combustion Step

In the combustion step, water is provided by combusting methane contained in the biogas.

Furthermore, the heat generated in the combustor may be supplied to the reforming step. That is, the heat generated in the combustion step is supplied to the reforming step in which an endothermic reaction is performed. A portion of the third gas containing water and carbon dioxide produced from the combustion step may also be supplied to the reforming step.

In this regard, the third gas discharged from the combustion step may have a temperature of 350° C. or higher than 350° C., 380° C. or higher than 380° C., 400° C. or higher than 400° C., 550° C. or lower than 550° C., 530° C. or lower than 530° C., or 500° C. or lower than 500° C. As a result, the third gas may contain water in a form of water vapor and carbon dioxide in a form of the gas phase.

The method for preparing hydrogen may include a second heat-exchange step of cooling the third gas to separate the third gas into the gas and liquid.

### Second Heat-Exchange Step

In the second heat-exchange step, the third gas discharged from the combustion step is cooled to be separated into gas and liquid. In this regard, the gas-liquid separation may be to separate the third gas into water and carbon dioxide.

The cooling may be to bring the temperature of the third gas to room temperature, for example, 15° C. or higher than 15° C., 18° C. or higher than 18° C., 20° C. or higher than 20° C., 30° C. or lower than 30° C., 28° C. or lower than 28° C., or 25° C. or lower than 25° C. When the target temperature of the cooling is within the above range, the gas-liquid separation performance may be increased, so that the water separation effect may be improved and only water may be supplied to the reformer.

The third gas may be cooled in the second heat-exchange step and thus may be subjected to gas-liquid separation into water in a form of a liquid phase and carbon dioxide in a form of a gas phase. In this regard, the water in a form of the liquid phase in the third gas may be supplied to the reforming step, and the carbon dioxide in a form of the gas phase in the third gas may be discharged to the outside thereof.

The water discharged from the second heat-exchange step may be supplied to the reforming step.

For example, the water discharged from the second heat-exchange step may be liquid, and a temperature thereof may be room temperature, for example, 15° C. or higher than 15° C., 18° C. or higher than 18° C., 20° C. or higher than 20° C., 30° C. or lower than 30° C., 28° C. or lower than 28° C., or 25° C. or lower than 25° C. When the temperature of the water discharged from the second heat-exchange step is within the above range, only water may be reused in the reformer, improving steam reactivity.

### Water Gas Shift Step

In the water gas shift step, the second gas containing hydrogen and carbon dioxide is produced from the third reaction of carbon monoxide contained in the first gas and water.

The third reaction may be a water gas shift reaction (WGS) (CO+H₂O→CO₂+H₂).

Furthermore, the water gas shift step may be performed in the presence of a catalyst for the third reaction, that is, the water gas shift reaction (WGS). The WGS catalyst may be used without particular limitations thereto as long as the WGS catalyst is typically used in WGS, and is able to be prepared and/or available for purchase.

A content of the separate water supplied to the water gas shift step may be 1.2 mol or larger than 1.2 mol, 1.3 mol or larger than 1.3 mol, 1.5 mol or larger than 1.5 mol, 1.8 mol or larger than 1.8 mol, 2.5 mol or smaller than 2.5 mol, 2.3 mol or smaller than 2.3 mol, 2.2 mol or smaller than 2.2 mol, or 2.1 mol or smaller than 2.1 mol, relative to the number of moles of carbon monoxide. That is, the water gas shift reaction involves a reaction at a 1:1 molar ratio of carbon monoxide and water. However, carbon monoxide and water may be supplied to the water gas shift step so that the molar ratio of water and carbon monoxide is in a range as described above. When the molar ratio of water and carbon monoxide supplied to the water gas shift step is within the above range, the shift percentage of carbon monoxide may be improved, improving the hydrogen production rate.

As described above, an amount of the water supplied to the water gas shift step may exceed an amount thereof required for the third reaction. As a result, the second gas discharged from the water gas shift reactor may contain water.

For example, the water supplied separately to the reforming step may be water contained in the second gas discharged from the water gas shift step. Referring to FIG. 4, the method for preparing hydrogen according to an exemplary embodiment of the present disclosure may supply the water B contained in the second gas D discharged in the water gas shift step to the reforming step.

The third reaction may have a reaction temperature of 150° C. or higher than 150° C., 180° C. or higher than 180° C., 200° C. or higher than 200° C., 350° C. or lower than 350° C., 320° C. or lower than 320° C., or 300° C. or lower than 300° C. That is, the prepared second gas may have a temperature of 150° C. or higher than 150° C., 180° C. or higher than 180° C., 200° C. or higher than 200° C., 350° C. or lower than 350° C., 320° C. or lower than 320° C., or 300° C. or lower than 300° C. As a result, the second gas may contain water in a form of water vapor and carbon dioxide in a form of the gas phase.

The method for preparing hydrogen may include a first heat-exchange step of cooling the second gas to separate the second gas into the gas and liquid.

### First Heat-Exchange Step

The first heat-exchange step cools the second gas discharged from the water gas shift step to separate the second gas into gas and liquid. In this regard, the gas-liquid separation may be to separate the second gas into water and carbon dioxide.

The cooling may be to bring the temperature of the second gas to room temperature, for example, 15° C. or higher than 15° C., 18° C. or higher than 18° C., 20° C. or higher than 20° C., 30° C. or lower than 30° C., 28° C. or lower than 28° C., or 25° C. or lower than 25° C. However, the target temperature is not limited thereto. The second gas may be cooled in the first heat-exchange step and thus may be subjected to gas-liquid separation into water in a form of a liquid phase and carbon dioxide in a form of a gas phase. In this regard, the water in a form of the liquid phase in the second gas may be supplied to the reforming step, and the carbon dioxide in a form of the gas phase in the second gas may be discharged to the outside thereof.

The water discharged from the first heat-exchange step may be supplied to the reforming step for reuse.

For example, the water discharged from the first heat-exchange step may be liquid, and a temperature thereof may be room temperature, for example, 15° C. or higher than 15° C., 18° C. or higher than 18° C., 20° C. or higher than 20° C., 30° C. or lower than 30° C., 28° C. or lower than 28° C., or 25° C. or lower than 25° C. When the temperature of the water discharged from the first heat-exchange step is within the above range, only the water produced during the process may be reused in the reformer, improving steam reactivity.

The method for preparing hydrogen according to an exemplary embodiment of the present disclosure may include an adsorbing step for separating and purifying the second gas discharged from the water gas shift step.

### Adsorbing Step

The adsorbing step may adsorb, separate, and purify the second gas discharged from the water gas shift step, and thus discharge the hydrogen gas and carbon dioxide, respectively.

Furthermore, the adsorbing step may be used without particular limitations thereto as long as the adsorbing step is generally usable in adsorbing, separating, and purifying hydrogen gas from mixed gas. For example, the adsorbing step may include performing pressure swing adsorption (PSA).

The method for preparing hydrogen may be configured for controlling the flow rate of water supplied separately to the reforming step. As described above, controlling the flow rate of water supplied separately to the reforming step may allow the reaction rate of each of the first and second reactions of the reforming step to be controlled. As a result, the method for preparing hydrogen may have a more excellent hydrogen production yield.

In the method for preparing hydrogen according to an exemplary embodiment of the present disclosure as described above, water is supplied separately during the reforming reaction so that the dry reforming and the steam reforming are performed simultaneously, achieving the excellent hydrogen production yield. Furthermore, the method for preparing hydrogen may reduce the occurrence of the coking caused by thermal decomposition of methane, preventing the decrease in the activity of the reforming catalyst.

Hereinafter, the present disclosure will be described in more detail through Examples. However, these Examples are only intended to help understanding the present disclosure and do not limit the scope of the present disclosure to these Examples.

### EXAMPLE

### Example 1. Preparing Hydrogen Gas

Hydrogen gas was prepared using the hydrogen gas preparation equipment including the structure shown in FIG. 4. In this regard, mixed gas composed of 60% by volume of methane gas as the biogas A and 40% by volume of carbon dioxide was used as a raw material. The reformer operated at 850±50° C., and the water gas shift reactor operated at 250±50° C. Furthermore, the molar ratio of water (H₂O) and carbon monoxide (CO) supplied to the water gas shift reactor was adjusted to 2:1.

In this regard, the reformer operated while controlling the molar ratio of methane in the biogas supplied to the reformer and water supplied separately to the reformer. S/C in Table 1 is the Steam to Carbon ratio, i.e., the molar ratio of methane in the biogas and the separately supplied water.

TABLE 1

| Reformer | | | | | | | | | | Methane | |
|---|---|---|---|---|---|---|---|---|---|---|---|
| S/C | Gas composition | | | | Gas composition | | | | | Shift | |
| Molar | at reformer inlet | | | | at reformer outlet | | | | | Percentage | |
| Ratio | H₂ | CO | CO₂ | CH₄ | H₂O | H₂ | CO | CO₂ | CH₄ | H₂O | |
| 0.00 | 0 | 0 | 0.4 | 0.6 | 0 | 0.705 | 0.745 | 0.017 | 0.237 | 0.020 | 60% |
| 0.10 | 0.109 | 0.007 | 0.450 | 0.612 | 0.061 | 0.966 | 0.845 | 0.036 | 0.188 | 0.051 | 69% |
| 0.20 | 0.235 | 0.015 | 0.501 | 0.618 | 0.124 | 1.195 | 0.923 | 0.060 | 0.151 | 0.098 | 76% |
| 0.30 | 0.372 | 0.023 | 0.556 | 0.621 | 0.186 | 1.394 | 0.986 | 0.088 | 0.124 | 0.157 | 80% |
| 0.40 | 0.517 | 0.031 | 0.612 | 0.622 | 0.249 | 1.573 | 1.041 | 0.119 | 0.106 | 0.226 | 83% |
| 0.50 | 0.666 | 0.039 | 0.672 | 0.623 | 0.312 | 1.740 | 1.091 | 0.150 | 0.092 | 0.301 | 85% |
| 0.60 | 0.825 | 0.047 | 0.732 | 0.624 | 0.374 | 1.899 | 1.138 | 0.182 | 0.083 | 0.383 | 87% |
| 0.70 | 0.986 | 0.056 | 0.795 | 0.624 | 0.437 | 2.052 | 1.184 | 0.215 | 0.076 | 0.468 | 88% |

As shown in Table 1, it was identified that as the S/C ratio as the molar ratio of methane in the biogas and the water supplied to the reformer increased, the methane shift percentage was improved, improving the hydrogen production yield.

The method for preparing hydrogen according to an exemplary embodiment of the present disclosure separately supplies the water during the reforming reaction so that the dry reforming and the steam reforming are simultaneously performed, achieving the excellent hydrogen production yield. Furthermore, the method for preparing hydrogen reduces the occurrence of the coking caused by thermal decomposition of methane, preventing deterioration of the activity of the reforming catalyst.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “or” used in an exemplary embodiment of the present disclosure should be interpreted as indicating “additionally or alternatively.”

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

The terms used to describe the exemplary embodiments are used for describing specific embodiments, and are not intended to limit the embodiments. As used in the description of the exemplary embodiments and in the claims, the singular forms “a”, “an”, and “the” include plural referents unless the context clearly dictates otherwise. The expression “and/or” is used to include all possible combinations of terms.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

As used herein, conditional expressions such as “if” and “when” are not limited to an optional case and are intended to be interpreted, when a specific condition is satisfied, to perform the related operation or interpret the related definition according to the specific condition.

Terms such as first and second may be used to describe various elements of the embodiments. However, various components according to the exemplary embodiments should not be limited by the above terms. These terms are only used to distinguish one element from another.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for preparing hydrogen, the apparatus comprising:
a reformer inducing a first reaction of methane contained in biogas and carbon dioxide and a second reaction of the methane contained in the biogas and separately supplied water to produce first gas containing hydrogen and carbon monoxide; and
a water gas shift reactor connected to the reformer and inducing a third reaction of the carbon monoxide contained in the first gas and water to produce second gas containing hydrogen and carbon dioxide,
wherein the separately supplied water is water contained in the second gas discharged from the water gas shift reactor or water obtained by combusting methane contained in the biogas.

2. The apparatus of claim 1,
wherein the first reaction and the second reaction are performed at a temperature in a range of 750° C. inclusive to 950° C. inclusive,
wherein the third reaction is performed at a temperature in a range of 150° C. inclusive to 350° C. inclusive.

3. The apparatus of claim 1, wherein a molar ratio of the biogas and the water in the first reaction and the second reaction is in a range of 1:0.3 inclusive to 0.7 inclusive.

4. The apparatus of claim 1, wherein a downstream side of the water gas shift reactor and the reformer is connected and the water contained in the second gas as discharged from the water gas shift reactor is supplied to the reformer.

5. The apparatus of claim 1, further including:
a first heat-exchanger connected to the water gas shift reactor and cooling the second gas discharged from the water gas shift reactor to separate the second gas into gas and liquid,
wherein water discharged from the first heat-exchanger is supplied to the reformer for reuse.

6. The apparatus of claim 5, further including an adsorber connected to the first heat-exchanger and configured to separate and purify the second gas discharged from the water gas shift reactor.

7. The apparatus of claim 1, further including:
a combustor connected to the reformer and combusting the methane contained in a portion of the biogas to produce third gas containing water and carbon dioxide,
wherein the water discharged from the combustor is supplied to the reformer.

8. The apparatus of claim 7, further including:
a second heat-exchanger connected to the combustor and the reformer and cooling the third gas to separate the third gas into gas and liquid,
wherein water discharged from the second heat-exchanger is supplied to the reformer.

9. The apparatus of claim 1, further including:
a control valve configured to control a flow rate of the water to be separately supplied to the reformer.

10. A method for preparing hydrogen, the method comprising:
a reforming step of inducing a first reaction of methane contained in biogas and carbon dioxide and a second reaction of the methane contained in the biogas and separately supplied water to produce first gas containing hydrogen and carbon monoxide; and
a water gas shift step of inducing a third reaction of the carbon monoxide contained in the first gas and water to produce second gas containing hydrogen and carbon dioxide,
wherein the separately supplied water is water contained in the second gas discharged from the water gas shift step or water obtained by combusting methane contained in the biogas.

11. The method of claim 10, wherein the reforming step is performed at a temperature in a range of 750° C. inclusive to 950° C. inclusive,
wherein the water gas shift step is performed at a temperature in a range of 150° C. inclusive to 350° C. inclusive.

12. The method of claim 10, wherein a molar ratio of the biogas supplied to the reforming step and the water supplied separately to the reforming step is in a range of 1:0.3 inclusive to 0.7 inclusive.

13. The method of claim 10, further including:
a first heat-exchange step of cooling the second gas discharged from the water gas shift step to separate the second gas into gas and liquid, producing water,
wherein the water produced from the first heat-exchange step is supplied to the reforming step for reuse.

14. The method of claim 10, further including:
a combustion step of combusting the methane contained in the biogas to produce third gas containing water and carbon dioxide,
wherein the water discharged from the combustion step is supplied to the reforming step.

15. The method of claim 14, further including:
a second heat-exchange step of cooling the third gas to separate the third gas into gas and liquid,
wherein water discharged from the second heat-exchange step is supplied to the reforming step.
